(19) United States
(12) Patent Application Publication
(10) Pub. No.: US 2025/0319472 A1
(43) Pub. Date: Oct. 16, 2025

(54) INTERCHANGEABLE CARTRIDGE DEVICES WITH PROTECTIVE BLADE MEMBER FOR GRATING INGESTIBLE SUBSTANCES

(71) Applicant: Alex L. Liu, Beaverton, OR (US)

(72) Inventor: Alex L. Liu, Beaverton, OR (US)

(21) Appl. No.: 19/036,107

(22) Filed: Jan. 24, 2025

Related U.S. Application Data
(60) Provisional application No. 63/625,273, filed on Jan. 25, 2024.

(51) Int. Cl. B02C 18/10; A47J 42/28; B02C 18/18; B02C 18/22

(52) U.S. Cl. CPC B02C 18/10; B02C 18/182; B02C 18/2233; A47J 42/28

(57) ABSTRACT

Interchangeable cartridge devices, driven by an external actuator, for use in grating an ingestible substance. The devices may include an assembly with an cavity defining structure and a grating blade coupled to the assembly. A plunger moves within this cavity and is biased towards the grating blade. The plunger is configured to push a substance to be grated into and through the grating blade. Various embodiments are disclosed featuring narrow and wider cavities, different driving structures, a plunger with a plurality of independently biased sections, and releasable components for repair, cleaning and replacement, among other features.

### CROSS REFERENCE TO RELATED APPLICATIONS

This application claims the benefit of U.S. Provisional Application No. 63/625,273, filed Jan. 25, 2024, entitled Interchangeable Cartridge Devices for Grinding or Grating Ingestible Substances, and having the same inventor as above.

### FIELD OF THE INVENTION

The present invention relates to grating substances for food or drink, or other purposes. Further, the present invention relates to interchangeable cartridges that may be driven by an external actuator and achieve grating of a desired substance, and in a manner that protects the user's hand from the grating blade.

### BACKGROUND OF THE INVENTION

Chinese utility-model patent document no. 215820663 (pub date: Feb. 15, 2022) and nos. 215878197 and 215878198 (pub. date: Feb. 22, 2022) disclosed prior versions of an interchangeable cartridge device for grating a substance.

The embodiments disclosed in these documents are disadvantageous in that they jam easily, are unable to grate harder substances (nuts, dried/roasted beans, hard or whole spices, etc.) and/or are difficult to clean. These devices have a plunger member with a flat bottom that pushes downward a substance to be grated, pushing the substance into contact with a grating blade. The force provided by the flat bottom, however, is often insufficient to move the substance to be grated into and through the grating blade. The flat bottom may slide over of the substance or cause pieces to roll, rather than be pushed through the blade (for example, a nutmeg nut). And, if some grating does occur, the resultant fines may mat or cake up, rather than be pushed through, further impeding grating.

Furthermore, the central shaft of the prior art devices limits the volume or cavity size available to hold a substance to be processed, and may be less effective at evenly distributing a driving force across the plunger head than the present invention.

### SUMMARY OF THE INVENTION

It is an object of the present invention to overcome the shortcomings of the prior art.

It is another object of the present invention to provide an interchangeable cartridge (adapted to be driven by an actuator) that has a plunger with sloped, angled, or otherwise shaped faces that push a substance to be grated into and through a grating blade or other grating/grinding structure.

It is also an object of the present invention to provide such an interchangeable cartridge with a protective blade member.

It is yet another object of the present invention to provide such an interchangeable cartridge with a plunger that has individually biased sections to better accommodate different sized objects to be grated.

These and related objects of the present invention are achieved by use of the interchangeable cartridge devices with protective blade member for grating ingestible substances, and a system therefor, as described herein.

The attainment of the foregoing and related advantages and features of the invention should be more readily apparent to those skilled in the art, after review the following of more detailed description of the invention taken together with the drawings.

### BRIEF DESCRIPTION OF THE DRAWINGS

FIGS. 1 and 2 are a perspective view and an exploded view, respectively, of one embodiment of an cartridge device in accordance interchangeable grating with the present invention.

FIGS. 3 and 4 are cross-sectional views of the interchangeable grating cartridge device of FIG. 1-2, with the plunger in the down and up position, respectively.

FIG. 5 is an exploded view of an embodiment of a plunger arrangement (of the device of FIGS. 1-4) in accordance with the present invention.

FIG. 6 is a perspective view of the head of the plunger of FIG. 5.

FIG. 7 is a cross-sectional view of another embodiment of an interchangeable grating cartridge device with a narrower plunger in accordance with the present invention.

FIGS. 8-11 are exploded, cross-sectional and individual component views of another embodiment of an interchangeable grating cartridge device in accordance with the present invention.

FIGS. 12-15 illustrate components of the base assembly for releasable attachment of a blade member and relative movement of base assembly sections.

FIG. 16 is an exploded view of an interchangeable grating cartridge device having a plunger with independently biased sections in accordance with the present invention.

### DETAILED DESCRIPTION

While taught with selected embodiments below, it is to be understood that the present invention includes all grating implements and techniques, including, but not limited to, a conventional grater, a rasper, a slicer, a shredder, a Japanese grater (for example, for ginger), a sharkskin grater, and others. In general, the term grater refers to moving a substance to be grated over a surface that has grating blades, slots, ridges, nubs, or is otherwise configured to reduce a given material into smaller size pieces or particles.

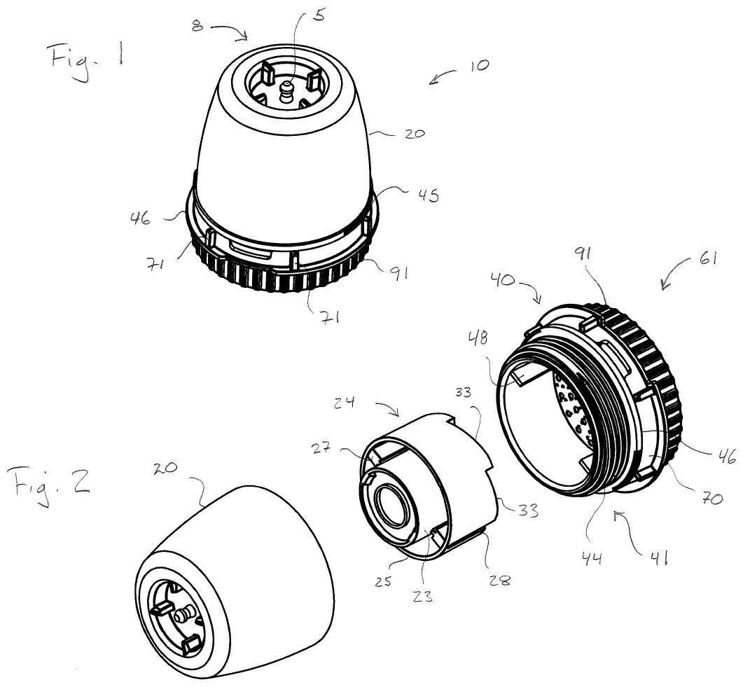

Referring to FIG. 1, an embodiment of an interchangeable cartridge device 10 for use in grating in accordance with the present invention is shown. Cartridge 10 is of a type that can be actuated by an external actuator such as that taught in the interchangeable cartridge system disclosed in U.S. Pat. No. 1,201,649, issued to Liu (the inventor herein) on Jun. 25, 2024, and entitled Spice or Other Substance Grinding Apparatus with Interchangeable Substance Containers (which is hereby incorporated by reference).

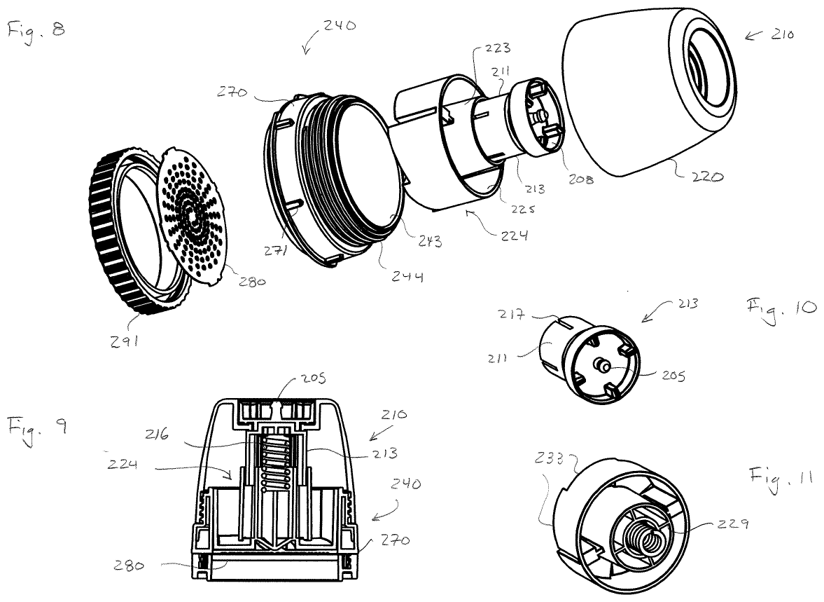

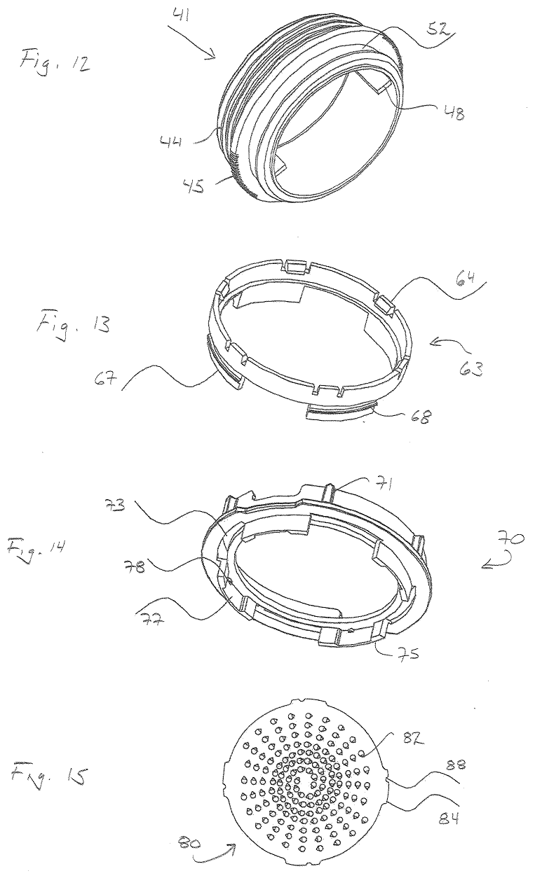

Cartridge 10 may include a housing 20 and a base assembly 40 that are coupled to one another, preferably through releasable attachment. The base assembly 40 preferably includes an upper section 41 and a lower section 61 that rotate relative to one another (yet may be otherwise configured as taught with reference to FIGS. 8-11, or other).

In the embodiment of FIGS. 1-4, the releasable attachment of the housing to the base assembly is achieved through externally threads that are disposed 44 complementary to threads provided on the inside of housing 20 (though other releasable structures may be used without departing from the present invention). A roughened surfaces 45 (formed of small closely spaced protrusion) disposed about sides of a flange 46 allow a user to securely hold base assembly 40 in one hand while screwing housing 20 on or off with the other hand.

In a top region of the housing, there is a knob or related structure 5 for releasable attachment to an actuator (preferably toggle-on, toggle-off). There is also a drive force receiving structure 8 (formed of a recess with a plurality of contact face supporting protrusions, as shown) that is adapted to engage a complementary-shaped drive mechanism of an actuator such that, when engaged, a driving force from that actuator causes rotational movement of the force receiving structure, housing and upper base assembly (as taught in the above-referenced patent).

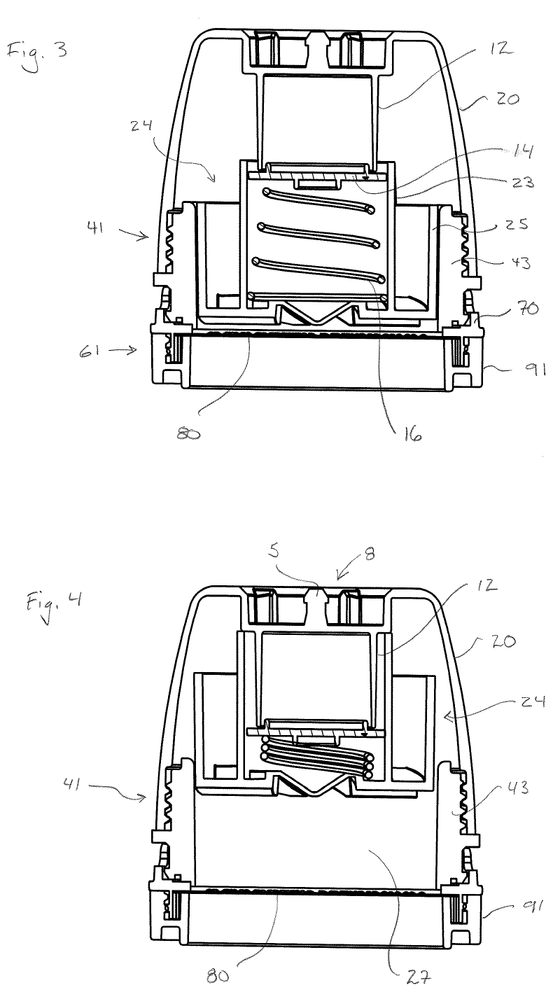

Internal to the housing is a preferably cylindrical support 12 having a plate 14 provided towards a bottom thereof (from the perspective of FIG. 3). A plunger (a structure that pushes a substance to be processed towards the processing blades) 24 slides up and down support 12 (guided by a columnar shaft 23) and is biased downwardly by bias member 16, here a spring, that is provided between plunger 24 and plate 14. FIG. 3 shows the plunger pushed down or extended, while FIG. 4 shows the plunger pushed up and bias member 16 compressed. The void exposed by the retracted plunger is the cavity 27 that holds substances to be grated.

An annular cavity defining member or structure 43 ascends from the main base assembly and defines the cavity that plunger 24 moves up and down in. A grating blade member 80 defines the bottom of the cavity.

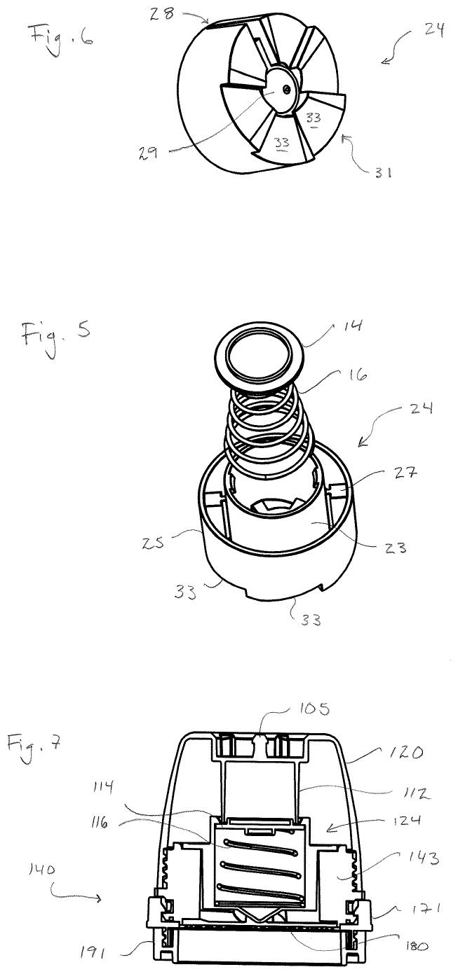

FIG. 5 is an exploded view of the plunger, bias member and plate. FIG. 6 is a perspective view of the plunger force applying structure or “head” 31. Plunger head 31 preferably has a plurality of sloped faces 33, six in FIG. 6, though this number may vary based on intended use. The faces are preferably sloped and configured to push a substance into and through the grating slots, blades, or nubs of grating blade 80 (discussed below).

Various face configuration and slopes are possible based on the substance to be processed. The slope of the faces shown in FIG. 6 may be between 1 and 45 degrees (or more), or between 2 and 35, or between 3 and 20 or 25 degrees or otherwise configured, including being greater than 45 degrees, and may be roughened or undulated or otherwise configured. Bolt 29 represents the ability to replace or change heads when an existing head is worn out or another configuration is desired. It should be recognized that the head may also be formed integrally with the plunger and the entire plunger swapped out when worn or another face arrangement is desired.

Plunger 24 has structures 27 that define slots 28 located toward periphery that the thereof are complementary to drive members 48 formed on an interior of the upper base assembly. While two slots 28 and members 48 are shown in FIG. 2, the number and arrangement of slots and members may vary without departing from the present invention. The plunger slides onto these members and is driven to rotate as the upper base assembly rotates (as it is driven through connection to the force receiving structure 8).

The base assembly is described in more detail below with respect to FIGS. 12-14, yet it is discussed here to introduce one embodiment of how the plunger rotates relative to grating blade 80. The base assembly preferably has a coupling flange 52 (obscured from view in FIGS. 1 and 2, yet shown in FIG. 12) below flange 46 and an annular mounting bracket 63 that includes circumferentially spaced tabs 64 that click over the coupling flange, in a manner that secures the mounting bracket to the flange yet allows low friction rotation of the bracket around the flange (i.e., rotation of the bracket and lower assembly relative to the upper assembly).

A docking ring 70 is coupled to mounting bracket 63 and includes a plurality of exteriorly disposed docking protrusions or nubs 71 that are configured to engage a complementary structure within an actuator (as known in the art) such that when the cartridge is inserted into the actuator, the lower assembly 61, which holds the grating blade 80, is held in place while to upper assembly 41 (that has the plunger) is driven by the actuator.

This rotation of the plunger causes material within cavity 27 to be pushed by faces 33 into the slots, blades, ridges, or nubs of grating blade 80.

Referring to FIG. 7, another embodiment of an interchangeable cartridge device 110 for use in grating in accordance with the present invention is shown. Cartridge 110 is similar to cartridge 10 of FIGS. 1-6, yet the plunger 124 and accompanying cavity defining structure 143 are narrower than in device 10. A narrower cavity may be good for grating substance of which a smaller amount is needed or that are harder and thus require more power. For example, the narrower cavity may be well suited for nutmeg or cinnamon which are harder and/or typically consumed in smaller quantities.

Referring to FIGS. 8-11, another embodiment of an interchangeable cartridge device 210 for use in grating in accordance with the present invention is shown. Cartridge 210 is similar to cartridge device 10 of FIGS. 1-6, yet different in that it has an “internal drive” arrangement (i.e., the drive force receiving structure is not fixedly coupled to the housing, and rotates relative thereto), among other differences.

Cartridge 210 includes a housing 220 and a base assembly 240 that may be releasably attached thereto. In contrast to cartridge 10, a “plug” 213 is provided that receives the driving force from an actuator and delivers it to the plunger 224. Releaseable attachment knob 205 and drive force receiving structure 208 are configured as part of the plug, which is mounted through housing 220 such that it rotates in response to a driving force, while the housing does not.

Plug 213 further includes a plunger engaging structure 211 that has a plurality of slots 217 (4 in FIGS. 8-10) that slide over fins 219 within an inner cylinder of plunger 224. A force rotating drive plug 213 rotates plunger 224 and faces 226 to achieve in turn grating. Upper base assembly 241 does not have drive members (48 of FIG. 2) and hence plunger 224 rotates freely within base assembly 240 and within its cavity 227 (similarly bounded by a cavity defining structure 243 ascending from the main base assembly 240). Drive plug 213 further serves to more evenly distribute the drive force across the plunger faces than a single shaft, for a better and more consistent output product.

Docking nubs 271 serve a similar purpose as nubs 71 above. They allow the base assembly 240 to seat within an actuator and be held in place, holding the grating plate 280 stationary, while the plunger is rotated.

In cartridge 210, there are no separately rotatable upper and lower base assemblies. They are configured as one unit that holds the grating blade and aligns the plunger with the grating blade.

A bias member (here a spring) 216 biases the plunger is a manner similar to bias member 16 of FIG. 3, although narrower in shape given the narrower construction of plug 213.

Referring to 12-15, perspectives views are shown of components of base assembly 40 that allow movement of the upper base assembly 41 relative to the lower base assembly 61 and the easy-on, easy-off nature of the components that allows ready cleaning, maintenance and mounting or replacement of the grating blade 80, 180, 280, 380.

FIG. 12 illustrates upper base assembly 41 and threads 44, grip sections 45, main flange 46, and the smaller coupling flange 52.

FIG. 13 illustrates mounting bracket 63 with tabs 64. Mounting bracket 63 is pushed upward onto the bottom of the upper base assembly until tabs 64 snap over coupling flange 52. Mounting bracket 63 (of the lower base assembly) is then securely mounted to the upper base assembly, yet freely rotates thereon. Mounting bracket 63 also includes downward extensions 67, each with an outwardly disposed section of a screw thread 68 that affords screw-off/screw-on mounting of blade lock ring 91 (shown in FIGS. 1-2 and 16, among others).

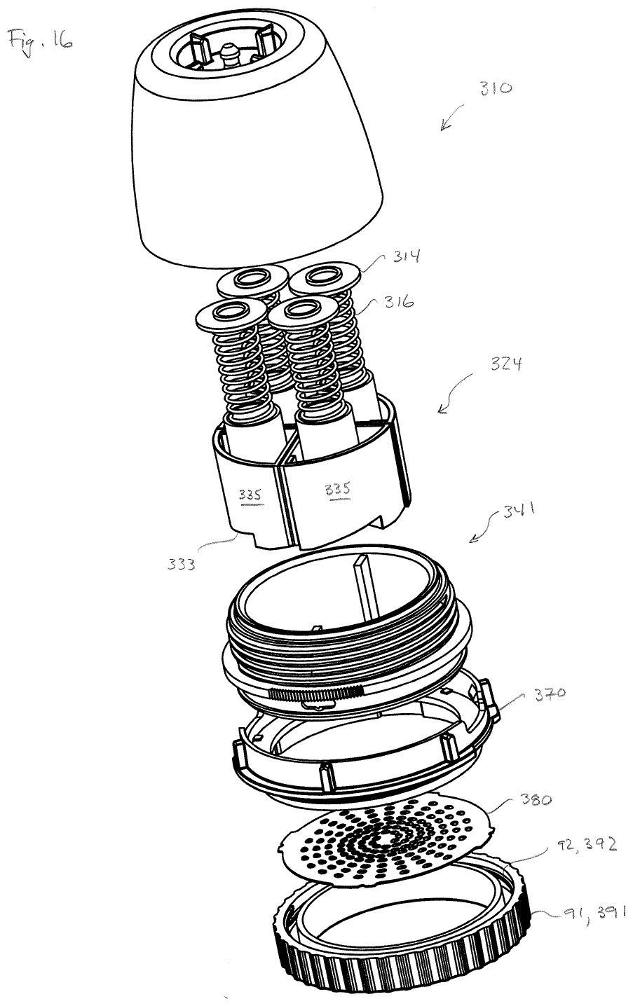

FIG. 14 illustrates the docking ring 70. Docking ring 70 includes the nubs 71 mentioned above, coupling slots 73, circumferential section supports 75, and receiving bays 77, each with an “idiot proofing” bump 78, for receiving the grating blade 80. The docking ring is mounted onto mounting bracket 63 such that extensions 67 slide into slots 73, exposing thread sections 68 towards the bottom of the docking ring 70 and disposed outwardly between the support sections 75.

FIG. 15 illustrates one embodiment of a grating plate 80. The grating plate may include a plurality of blades or abrading structures 82 for cutting, grating, slicing, grinding and/or otherwise abrading a substance in the cavity. The grating blade also has specially configured positioning tabs 84 that fit within the receiving bays 77 of the docking ring. The off-set location of bumps 78 and notches 88 assure that the blade can only be inserted with the grating slots/surface oriented towards the cavity and plunger.

In use, a grating blade is inserted into the bottom of the docking ring and then the blade lock ring 91 is screwed on to thread sections 68. FIG. 16 shows a complementary thread 92, 392 within ring 91, 391. This easy screw-on, screw-off structure allows a user to readily change grating plates, for example, to grate at a different fineness or to grate a different material, or for cleaning or blade replacement, etc.

Referring to FIG. 16, yet another embodiment of an interchangeable cartridge device 310 for use in grating in accordance with the present invention is shown. Device 310 is similar to other interchangeable cartridge devices disclosed herein, yet the plunger 324 has a plurality of individually biased sections 335 that may move up and down independently. Each has a separate bias member 316 and plate 314. Movement of these sections independently better accommodates different sized materials to be grated, such as different size cubes or pieces of cheese, or different sized nuts or cinnamon pieces, or other. The various size pieces can be pushed into contact with the grating blade contemporaneously as the plunger rotates.

In FIG. 16, four sections 335 are shown, though more or less may be provided. Each section preferably has one or more faces 333 that may be configured like faces 33 of FIG. 6.

It should be noted that components 80, 180, 280, and 380 may be a “grating member.” This term is intended herein to include grating blades and grating plates, where grating blades include one or more blade-like structure(s) that cut pieces of a material, and grating plates include an abrading surface that breaks off pieces of a material. Some grating plates, such as a Japanese/ginger or sharkskin grater, etc., would require holes to pass fines out of the cartridge.

The present invention also preferably includes a mechanism to hold the plunger in the retracted position while cavity filling. This mechanism may take the form of a retractable pin or protrusion, or a toggle-on, toggle-off link internal to the housing, or other. Any temporary hold mechanism preferably has a counter-balance so as to not negatively influence rotation of the cartridge.

While the invention has been described in connection with specific embodiments thereof, it will be understood that it is capable of further modification, and this application is intended to cover any variations, uses, or adaptations of the invention following, in general, the principles of the invention and including such departures from e present disclosure as come within known or customary practice in the art to which the invention pertains and as may be applied to the essential features hereinbefore set forth, and as fall within the scope of the invention and the limits of the appended claims.

1. An interchangeable cartridge device for grating a substance, comprising:
a base assembly having a cavity defining structure ascending therefrom;
a plunger that moves within the cavity defining structure;
a blade member coupled to the base assembly;
a bias member that biases the plunger towards the blade member; and
a drive force receiving structure coupled to the plunger and configured such that a force driving the drive force receiving structure causes rotation of the plunger;
wherein the plunger rotates relative to the blade member; and
wherein the plunger has at least a first substance pushing face disposed toward the blade member and oriented other than in parallel with the principal plane of the blade member, to facilitate the pushing of a substance to be grated into and through the blade member.

2. The device of claim 1, wherein the plunger includes a plurality of substance pushing faces disposed toward the blade member and oriented other than in parallel with the principal plane of the blade member.

3. The device of claim 1, wherein the first face average slope of 1-45 degrees relative to a principal plane of the blade member.

4. The device of claim 1, wherein the first face has an average slope of from 2-35 degrees relative to a principal plane of the blade member.

5. The device of claim 2, wherein the plurality of faces includes 3 or more faces.

6. The device of claim 1, wherein the plunger includes 2 or more independently biased sections.

7. The device of claim 1, wherein the plunger includes 3 or more independently biased sections.

8. The device of claim 1, further comprising a housing that structurally couples the drive force receiving structure to the base assembly.

9. The device of claim 1, wherein the blade member is releasably coupled to the base assembly.

10. The device of claim 1, wherein the blade member includes at least one of a grating blade and a grating plate.

11. The device of claim 1, further comprising a releasable actuator mounting structure configured to function with an appropriately configured actuator to releasably mount the cartridge device to that actuator.

12. The device of claim 1, further comprising a retracted-plunger hold mechanism to releasably hold the plunger in a retracted position during filling.

13. An interchangeable cartridge device for grating an ingestible substance, comprising:
a base assembly having a cavity defining structure ascending therefrom;
a plunger that moves within the cavity defining structure;
a blade member coupled to the base assembly;
a bias member that biases the plunger towards the blade member;
a drive force receiving structure coupled to the plunger and adapted to be driven by an actuator, a force driving the drive force receiving structure causing rotation of the plunger; and
a releasable actuator mounting structure configured to function with an appropriately configured actuator to releasably mount the cartridge device to that actuator; and
wherein, in use, the blade member is non-rotatably secured to the base assembly and the plunger rotates relative to the blade member; and
wherein the plunger has at least a first substance pushing face disposed towards the blade member and oriented other than in parallel with the principal plane of the blade member, to facilitate the pushing of a substance to be grated into and through the blade member.

14. The device of claim 13, wherein the plunger includes a second substance pushing face disposed toward the blade member and oriented other than in parallel with the principal plane of the blade member.

15. The device of claim 14, wherein the first and second faces each have an average slope of 1-45 degrees relative to a principal plane of the blade member.

16. The device of claim 13, wherein the plunger includes a plurality of independently biased sections, each section having at least one face disposed toward the blade member and oriented other than in parallel with the principal plane of the blade member.

17. The device of claim 13, wherein the blade member is releasably coupled to the base assembly.

18. The device of claim 13, wherein the blade member includes at least one of a grating blade and a grating plate.

19. An interchangeable cartridge device for grating an ingestible substance, comprising:
a base assembly having a cavity defining structure ascending therefrom;
a plunger that moves within the cavity defining structure;
a blade member releasably coupled to the base assembly;
a bias member that biases the plunger towards the blade member; and
a drive force receiving structure coupled to the plunger such that rotation of the driving force receiving structure causes rotation of the plunger relative to the blade member;
wherein the plunger has at least a first face for pushing a substance to be grated into and through the blade member, the first face having an average slope that is other than parallel with a principal plane of the blade member.

20. The device of claim 19, wherein the plunger comprises a second face for pushing a substance to be grated into and through the blade member, the second face having an average slope that is other than parallel with a principal plane of the blade member; and
wherein the first and second faces each have an average slope of 1-45 degrees relative to a principal plane of the blade member.

21. The device of claim 20, wherein the plunger comprises a third face for pushing a substance to be grated into and through the blade member, the third face having an average slope that is other than parallel with a principal plane of the blade member; and
wherein the first, second and third faces each have an average slope of 2-35 degrees relative to a principal plane of the blade member.

22. The device of claim 19, wherein the plunger includes a plurality of independently biased sections, each section having at least one face disposed toward the blade member and oriented other than in parallel with the principal plane of the blade member.
